(19) United States
(12) Patent Application Publication
(10) Pub. No.: US 2026/0268475 A1
(43) Pub. Date: Sep. 10, 2026

(54) ABNORMALITY DETECTION SYSTEM AND ABNORMALITY DETECTION METHOD

(71) Applicant: HITACHI KOKUSAIELECTRIC INC., Tokyo (JP)

(72) Inventor: HIROTO SASAO, TOKYO (JP)

(21) Appl. No.: 19/167,592

(22) PCT Filed: Sep. 22, 2023
(86) PCT No.: PCT/JP2023/034586

§ 371 Date: Sep. 22, 2025

(30) Foreign Application Priority Data
Mar. 22, 2023 (JP) 2023-045392

(51) Int. Cl. G06T 7/00; G06T 5/60

(52) U.S. Cl. CPC G06T 7/001; G06T 5/60; G06T 2207/20081; G06T 2207/30108

(57) ABSTRACT

Provided is an abnormality detection system for detecting abnormality in captured image data of an object, comprising: a first AI model trained with a normal image of the object as training data; a reconstruction part configured to generate reconstructed image data from the captured image data using the first AI model; a second AI model trained to extract a difference from two image data having the difference; a difference extraction part configured to extract difference image data from the captured image data and the reconstructed image data using the second AI model; and an abnormality extraction part configured to extract an abnormal portion from the difference image data.

### TECHNICAL FIELD

The present disclosure relates to an abnormality detection system that uses artificial intelligence (AI) to detect abnormality in a captured image; and, more particularly, to an abnormality detection system and an abnormality detection method that can eliminate the discrepancy between normal/abnormal determination by AI and normal/abnormal determination by human eye.

### BACKGROUND

### Prior Art

Abnormality detection systems that automatically determine pass/fail (normal/abnormal) status of manufactured products using imaging devices such as industrial cameras or the like are becoming widespread. Recently, abnormality detection systems using AI have become mainstream.

In particular, in the systems that determine the pass/fail status of manufactured products, it is difficult to collect a large amount of abnormal data, so that methods such as auto encoder (AE) and inpainting, which can build AI using only normal data, are used.

In such methods, models are trained using only normal (non-defective product) image data. At the time of an operation, arbitrary data is inputted. If the arbitrary data is restored normally, it is determined to be normal. If the arbitrary data is not restored normally, it is determined to be abnormal.

The mainstream of conventional abnormality detection systems is to calculate and compare the difference between an input image and an image outputted by AI, and to determine an image to be abnormal when the difference exceeds a threshold value.

However, for example, simple comparison of pixel values may determine that there is a sufficient difference in a region where the difference is not apparent to human eye, such as differences in color tone or brightness of an image. On the other hand, simple comparison of pixel values may determine that there is not a sufficient difference in a region where the difference is apparent to human eye.

In other words, in the conventional abnormality detection system, when an input image and an image outputted by AI are compared, the discrepancy may occur between the normal/abnormal determination made by human eye and the normal/abnormal determination made by the simple comparison of the pixel values.

### Related Technology

International Publication No. WO 2022/201451 “Detection device and detection method” (Patent Document 1) is suggested as a related prior art.

Patent Document 1 discloses a detection device that prevents the normal/abnormal determination from being made by overlooking an object to be detected even when the object is shown in an extremely small region in an image.

### PRIOR ART DOCUMENTS

### Patent Documents

Patent document 1: International Publication No. WO 2022/201451

### SUMMARY

### Problems to Be Resolved by the Invention

As described above, in the conventional abnormality detection system, when an input image and an image outputted by AI are compared, the discrepancy occurs between the normal/abnormal determination made by simple comparison of pixel values and the normal/abnormal determination made by human eye.

In addition, in the conventional abnormality detection system, among the training data for AI that should be collected, it is difficult to collect abnormal data.

Further, Patent Document 1 does not disclose a configuration that uses AI to perform abnormality detection that is close to the normal/abnormal determination made by human eye.

The present disclosure has been made in consideration of the above-described circumstances, and aims to provide an abnormality detection system and an abnormality detection method that can train AI using training data that can be easily collected, and that can reduce the discrepancy between the normal/abnormal determination made by human eye and the normal/abnormal determination made by simple comparison of pixel values in the case of comparing an input image and an image outputted by AI.

### Means for Solving the Problems

In order to solve the conventional problems, the present disclosure provides an abnormality detection system for detecting abnormality in captured image data of an object, comprising a first AI model trained with a normal image of the object as training data, a reconstruction part configured to generate reconstructed image data from the captured image data using the first AI model, a second AI model trained to extract a difference from two image data having the difference, a difference extraction part configured to extract difference image data from the captured image data and the reconstructed image data using the second AI model, and an abnormality extraction part configured to extract an abnormal portion from the difference image data.

In addition, the present disclosure provides the abnormality detection system, wherein the two image data having the difference do not include abnormal data.

In addition, the present disclosure provides the abnormality detection system, wherein the second AI model is trained using difference ground truth image data, which is obtained by extracting the difference from the two image data having the difference, and difference image data generated from the two image data using the second AI model, such that the difference image data becomes identical to the difference ground truth image data.

In addition, the present disclosure provides the abnormality detection system, wherein the difference ground truth image data is an image data corrected based on the two image data having the difference so as to reflect difference perceived by human eye.

In addition, the present disclosure provides an abnormality detection method for detecting abnormality in captured image data of an object comprising generating reconstructed image data from the capture image data using a first AI model trained with a normal image of the object as training data, by a reconstruction part, extracting difference image data from the captured image data and the reconstructed image data using a second AI model trained to extract a difference from two image data having the difference, by a difference extraction part, and extracting an abnormal portion from the difference image data, by an abnormality extraction part.

### Effect of the Invention

In accordance with the present disclosure, the abnormality detection system for detecting abnormality in captured image data of an object includes the first AI model trained with normal images of a target object as training data, the reconstruction part configured to generate reconstructed image data from the captured image data using the first AI model, the second AI model trained to extract the difference from two image data having the difference, the difference extraction part configured to extract difference image data from the captured image data and the reconstructed image data using the second AI model, and the abnormality extraction part configured to extract an abnormal portion from the difference image data. Accordingly, the difference can be extracted with high accuracy by using AI for the difference extraction. Further, by training the second AI model to reflect the difference that can be recognized by human eye, it is possible to perform the abnormality detection in which the discrepancy with the determination by human eye is reduced.

Further, in accordance with the present disclosure, the abnormality detection system can deal with the case in which two image data having the difference do not include abnormal data, and thus can easily collect training data for the second AI model.

### BRIEF DESCRIPTION OF THE DRAWINGS

FIG. 1 is an explanatory diagram showing a schematic configuration of an abnormality detection system of the present disclosure.

FIG. 2 is a block diagram showing a configuration of an abnormality detection device.

FIG. 3 is an explanatory diagram showing a schematic operation of a first AI training part.

FIG. 4 is an explanatory diagram showing a schematic operation of a second AI training part.

### DETAILED DESCRIPTION

An embodiment of the present disclosure will be described with reference to the accompanying drawings.

### <Overview of Embodiment>

An abnormality detection system according to an embodiment of the present disclosure (the abnormality detection system of the present disclosure) is an abnormality detection system that detects abnormality in captured image data of an object, and includes a first AI model (reconstructed AI model) trained with normal images of the object as training data, a reconstruction part configured to generate reconstructed image data using the first AI model, a second AI model (difference extraction AI model) trained to extract a difference from two image data having the difference, a difference extraction part that inputs the image data and the reconstructed image data to the second AI model to extract difference image data, and an abnormality extraction part that extracts an abnormal part from the difference image data. The difference can be extracted with high accuracy by using AI for the difference extraction, and the abnormality detection in which the discrepancy with the determination by human eye is reduced by suppressing the influence of color or brightness can be performed by training the second AI to reflect the difference that can be recognized by human eye.

Further, an abnormality detection method according to an embodiment of the present disclosure is an abnormality detection method in the abnormality detection system of the present disclosure.

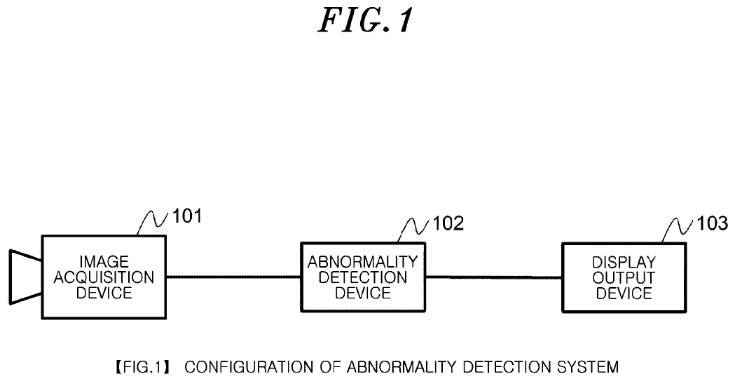

### <Schematic Configuration of Abnormality Detection System of Present Disclosure: FIG. 1>

The schematic configuration of the abnormality detection system of the present disclosure will be described with reference to FIG. 1. FIG. 1 is an explanatory diagram showing the schematic configuration of the abnormality detection system of the present disclosure.

As shown in FIG. 1, the abnormality detection system of the present disclosure basically includes an image acquisition device 101, an abnormality detection device 102, and a display output device 103.

The image acquisition device 101 is a device that acquires and outputs real-time or past video and still images. The image acquisition device 101 include, e.g., an industrial camera, a surveillance camera, a universal serial bus (USB) camera, a smartphone, a recorder or a player that can play a compact disc (CD), a hard disc drive (HDD), and a Blu-ray Disc (registered trademarks). Other cameras or image recording devices may also be used.

The abnormality detection device 102, which is a characteristic part of the abnormality detection system of the present disclosure, includes AI to detect whether the image inputted from the image acquisition device 101 is normal or abnormal.

The abnormality detection device 102 includes, as hardware, a processing device such as a central processing unit (CPU), a digital signal processor (DSP), a field programmable gate array (FPGA), or a graphics processing unit (GPU), a memory, a recording device, or the like. Further, other electronic devices or hardware may also be included.

The configuration and operation of the abnormality detection device 102 will be described later.

The display output device 103 outputs the results (abnormality) detected by the abnormality detection device 102 in the form of display or sound.

The display output device 103 may be, for example, a display with a personal computer (PC), a smartphone, a mobile phone, a business radio, an alarm device such as an alarm, or other device.

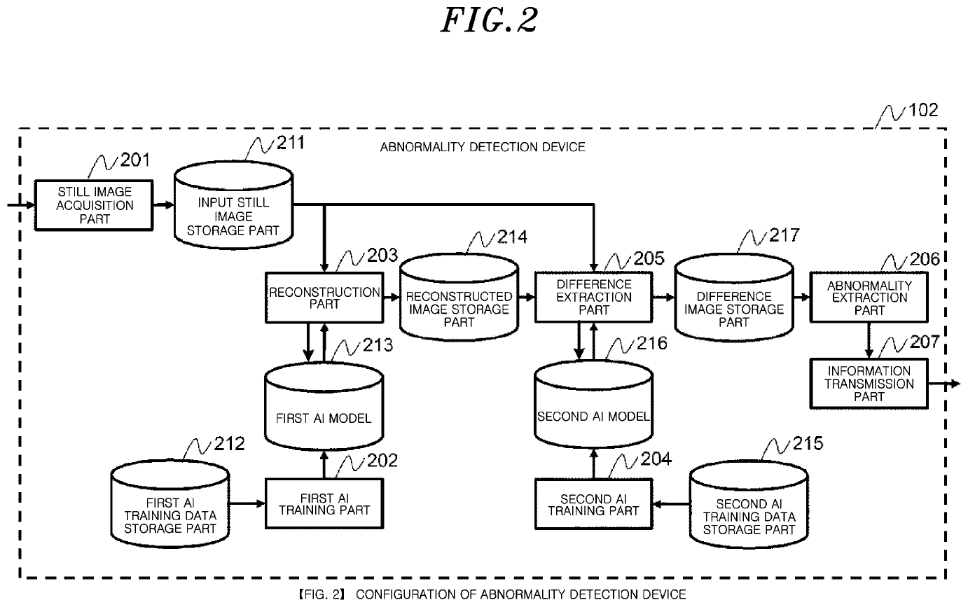

### <Configuration of Abnormality Detection Device 102: FIG. 2>

Next, the configuration of the abnormality detection device 102 will be described using FIG. 2. FIG. 2 is a configuration block diagram of the abnormality detection device.

As shown in FIG. 2, the abnormality detection device 102 basically includes a still image acquisition part 201, an input still image storage part 211, a first AI training data storage part 212, a first AI training part 202, a first AI model 213, a reconstruction part 203, a reconstructed image storage part 214, a second AI training data storage part 215, a second AI training part 204, a second AI model 216, a difference extraction part 205, a difference image storage part 217, an abnormality extraction part 206, and an information transmission part 207.

Hereinafter, the respective parts of the abnormality detection device 102 will be described.

The still image acquisition part 201 receives an image from the image acquisition device 101 and stores the still image in the input still image storage part 211.

Specifically, when the video (moving image) is inputted from the image acquisition device 101, the still image acquisition part 201 divides the video into frames, acquires each frame as an input still image, and stores the image in the input still image storage part 211. When the video is divided into single frames, the video may be divided every several frames.

In addition, when the still image is inputted from the image acquisition device 101, the still image acquisition part 201 stores it in the input still image storage part 211.

Here, the color space of the input still image is expressed in RGB (Red, Green, Blue), HSV (Hue, Saturation, Value), HLS (Hue, Luminance, Saturation), or other color spaces.

In addition, in order to reduce the influence of noise or flicker, the processing such as smoothing filtering, edge emphasis filtering, brightness conversion, histogram equalization, or the like may be performed as preprocessing. Further, in order to improve the accuracy of the abnormality detection and reduce the processing costs, the image may be enlarged or reduced to a predetermined size.

The input still image storage part 211 stores the still image inputted from the still image acquisition part 201.

The first AI training data storage part 212 stores training data (first AI training data) for the first AI training part 202 to train the first AI model 213. The first AI training data is a normal image of the abnormality detection target.

The first AI training part 202 uses the first AI training data to train the first AI model 213. The operation of the first AI training part 202 will be described later. The first AI training data 212 is inputted to the first AI model 213, and various parameters are adjusted and trained such that the inputted correct image and the image generated by the first AI model 213 become the same.

Since the training algorithm of the first AI is well known, the detailed description of the configuration will be omitted.

If the first AI training part 202 trains the first AI model 213 before the operation of the abnormality detection system of the present disclosure, the training may not be executed thereafter (after the operation is started), and the first AI model 213 may be re-trained irregularly or regularly.

The first AI model 213 is a trained AI model (reconstructed AI model) that has been trained to restore (reconstruct) and output an image that is the same as the input image when a normal image is inputted, and to generate and output an image different from the input image when an abnormal image is inputted. In other words, if the input still image from the input still image storage part 211 is a normal image, the first AI model 213 reconstructs and outputs an image that is the same as the input image.

The first AI model 213 is, for example, an AI model such as an auto encoder, a convolutional auto encoder (CAE), a variational auto encoder (VAE), inpainting after superimposition of a mask region, or other AI models capable of realizing reconstruction.

The reconstruction part 203 stores the reconstructed image generated from the input still image from the input still image storage part 211 using the trained first AI model 213 in the reconstructed image storage part 214. Specifically, the reconstruction part 203 inputs the input still image to the first AI model 213, and stores the generated reconstructed image in the reconstructed image storage part 214.

The second AI training data storage part 215 stores multiple sets of training data, each set including two images having a difference and an image (difference ground truth image) that shows the difference between the images detected by human eye. As will be described later, the second AI training data may be a set of images having a clear difference, and may be images unrelated to the object of abnormality detection when the abnormality detection system of the present disclosure actually operates.

The second AI training part 204 uses the second AI training data to train the second AI model 216.

The operation of the second AI training part 204 will be described later. The abnormality detection system of the present disclosure is characterized in that when two images having a difference are inputted, the second AI model 216 is trained to generate a difference image that is the same as an image (difference ground truth image) that reflects the difference recognized by human eye, regardless of differences in brightness or color tone.

In the difference ground truth image, the region where the difference is perceived by human eye is expressed as white, and the region where the difference is not perceived is expressed as black.

Further, if the second AI model 216 is trained before the operation, the training may not be executed after the operation is started, and the second AI model 216 may be re-trained irregularly or regularly.

The second AI model 216 is a trained AI model (difference extraction AI model) that extracts the difference between two input images and outputs it as a difference image. For example, the second AI model 216 is realized as an AI model for segmentation such as a fully convolutional network (FCN) with doubled input channels, a SegNet, or a U-Net, or may be an AI model that can realize other difference extraction.

The difference extraction part 205 generates the difference image using the second AI model 216 from the input still image from the input still image storage part 211 and the reconstructed image from the reconstructed image storage part 214, and stores the generated image in the difference image storage part 217. Specifically, the difference extraction part 205 inputs the input still image and the reconstructed image to the second AI model 216, acquires the difference image outputted from the second AI model 216, and stores it in the difference image storage part 217.

The difference image storage part 217 stores the difference image.

The abnormality extraction part 206 extracts an abnormal region using the difference image inputted from the difference image storage part 217.

The abnormality extraction part 206 binarizes (0 and 1) the difference image using a threshold value T2, performs an opening process that repeats contraction and expansion, and a closing process that repeats expansion and contraction to remove fine noise, and performs a labeling process to extract a region in the labeled region (white region) that has an area greater than a threshold value T3 as abnormality.

Due to the labeling process, it is possible to recognize the position, size, and number of regions (white portions) where the differences are extracted.

The order and number of times of the opening and closing processes can be changed for each target abnormal image, and the comparison target of the threshold T3 in the labeling process may be the vertical or horizontal length of the region.

Since the algorithms for the opening, closing, and labeling processes are well known, the detailed description thereof will be omitted.

The information transmission part 207 transmits the abnormality extracted by the abnormality extraction part 206 in a form suitable for the display output device 103, using images, text, voice, compressed data thereof, or other information forms.

### <Training of First AI Model 213 and Second AI Model 216>

Before the overall operation of the abnormality detection device 102 is described, the operation of the first AI training part 202 that trains the first AI model 213 and the second AI training part 204 that trains the second AI model 216 will be described.

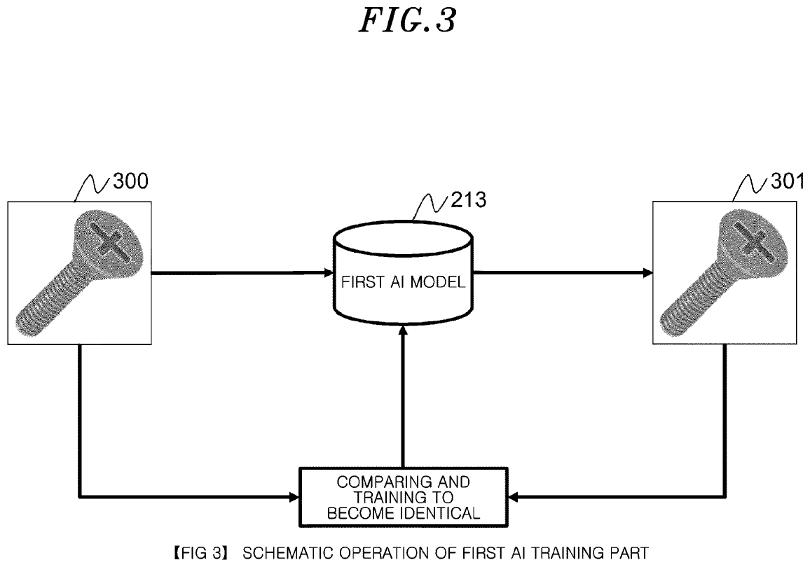

### <Schematic Operation of First AI Training Part: FIG. 3>

First, the schematic operation of the first AI training part 202 will be described using FIG. 3. FIG. 3 is an explanatory diagram showing the schematic operation of the first AI training part.

As shown in FIG. 3, the first AI training part 202 inputs the first AI training data 300 stored in the first AI training data storage part 212 to the first AI model 213 to generate a reconstructed image 301, compares the input image and the output image, and adjusts and trains the parameters of the first AI model 213 such that the input image and the output image become the same.

Here, the first AI training data is multiple normal images that show the target object of abnormality detection, and may be subjected to augmentation such as inversion, rotation, brightness conversion, noise removal, and noise addition. The color space and the image size are made to be the same as those of the input still image acquired by the still image acquisition part 201 at the time of the operation. Since it is easy to obtain normal images of the target object for abnormality detection, the first AI training data can be easily collected.

Due to the training, the first AI model 213 becomes a model that outputs a restored image that is the same as the normal image when the normal image is inputted.

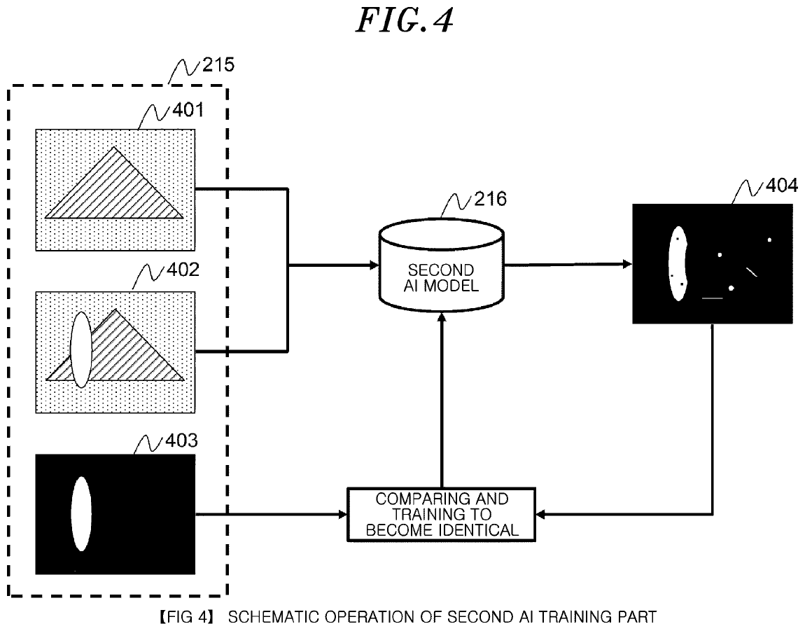

### <Schematic Operation of Second AI Training Part: FIG. 4>

Next, the schematic operation of the second AI training part 204 will be described using FIG. 4. FIG. 4 is an explanatory diagram showing the schematic operation of the second AI training part.

As shown in FIG. 4, in the second AI training part 204, two images having a difference (a set of difference extraction AI training data) are inputted into the second AI model 216, and the second AI model 216 is trained such that a difference image 404 generated by the second AI model 216 and a difference image (difference ground truth image) 403 determined by human eye become the same.

The second AI training data may be a moving object detection accuracy verification dataset, or the like. In FIG. 4, it is illustrated as a schematic figure for ease of understanding.

As shown in FIG. 4, the second AI training data is multiple sets of a background image 401, a foreground image 402 in which another object is superimposed on the background image 401, and the difference ground truth image 403 in which the difference between the background image 401 and the foreground image 402 is recognized by human eye.

The foreground image 402 is an image in the same position and viewing angle as the background image 401, containing people, cars, motorcycles, trains, airplanes, desks, chairs, tableware, and other living things and objects that are not included in the background image 401. The background image 401 and the foreground image 402 may be subjected to augmentation such as inversion, rotation, brightness conversion, noise removal, or noise addition, and the color space and the image size is made to be the same as those of the input still image inputted from the still image acquisition part 201 at the time of the operation.

The second AI training data may be an image that can be easily obtained, which is unrelated to the object of the abnormality detection at the time of the operation. Since there is no need to use images of defective products that are difficult to collect, the training data can be easily prepared.

The second AI training data storage part 215 stores in advance, as the second AI training data, multiple sets in which the background image 401 and the foreground image 402 that are known are made to correspond to the difference ground truth image 403.

The difference ground truth image 403 is not simply based on the difference in numerical values between the background image 401 and the foreground image 402, but is an image generated from the known background image 401 and the foreground image 402. Further, in the difference ground truth image 403, the region where the difference can be perceived by human eye is expressed as white (value “1”), and the region where the difference cannot be perceived by human eye is expressed as black (value “0”).

In other words, the difference ground truth image 403 is an image that reflects the recognition of the difference by human eye by suppressing the influence of differences due to factors other than the presence or absence of the object or the shape, such as brightness or color.

Further, the second AI training part 204 reads out the set of the background image 401 and the foreground image 402 from the training data stored in the second AI training data storage part 215, inputs it into the second AI model 216, compares the generated difference image 404 with the difference ground truth image 403 corresponding to the inputted set, and trains the second AI model 216 such that they become the same.

For example, for a certain region of the background image 401 and the foreground image 402, the difference in the output numerical value from the second AI model 216 may be greater than (different from) a certain threshold T1, but the same region may be black in the difference ground truth image 403. Similarly, for another region, the difference in the output numerical value from the second AI model 216 may be smaller than the threshold, but the corresponding region may be white in the difference ground truth image 403.

In other words, the discrepancy may exist between the difference detection by the second AI model 216 and the difference detection by human eye. In the abnormality detection system of the present disclosure, the second AI model 216 is trained to reduce the discrepancy.

FIG. 4 shows the difference image 404 in an insufficiently trained state. Since white dots exist in the black region, the difference image 404 is not the same as the difference ground truth image 403.

The second AI training part 204 adjusts and trains the parameters of the second AI model 216 such that the difference image 404 and the difference true image 403 become the same. Therefore, the second AI model 216 can perform the difference detection close to the determination by human eye.

### <Operation of Abnormality Detection Device 102: FIG. 2>

The operation of the abnormality detection device 102 will be described using FIG. 2. Here, it is assumed that the first AI model 213 and the second AI model 216 have already been trained, and the processes at the time of the operation will be described.

The still image acquisition part 201 appropriately processes the input image to generate a still image and stores it in the input still image storage part 211.

The input still image is inputted to the reconstruction part 203. The reconstructed image is generated and outputted using the first AI model 213, and stored in the reconstructed image storage part 214.

Then, the reconstructed image from the reconstructed image storage part 214 and the input still image from the input still image storage part 211 are inputted to the difference extraction part 205. The difference image is generated by extracting the difference using the second AI model 216, and the corresponding difference image is stored in the difference image storage part 217.

If the object in the input still image is normal, there is substantially no difference from the reconstructed image and, thus, the difference image is solid black. However, if there is abnormality in the object in the input still image, the difference from the reconstructed image increases, and a white region appears.

In particular, in the abnormality detection system of the present disclosure, as described above, the difference image generated by the second AI model 216 reflects the presence or absence of the difference that can be recognized by human eye. Thus, the abnormality detection close to the determination made by human eye can be performed.

The difference image is inputted to the abnormality extraction part 206. When the abnormality extraction part 206 extracts abnormality, the notification of the abnormality detection is outputted to the information transmission part 207, and the information transmission part 207 transmits information that notifies the abnormality in a predetermined form, such as display data or audio data.

In this manner, the abnormality detection device 102 operates.

Accordingly, in the abnormality detection system of the present disclosure, the training can be performed without using defective products as the training data for the second AI model 216, so that the abnormality detection close to the sense of human eye can be performed. Hence, the abnormality detection system of the present disclosure can be applied to various industrial fields, such as sorting of agricultural products, or abnormality detection systems in production lines for processed food products or parts.

### <Effects of Embodiment>

The abnormality detection system of the present disclosure detects abnormality in the capture image data of an object, and includes the first AI model 213 that has been trained using the normal image of the object as the training data, the reconstruction part 203 that inputs the captured image data to the first AI model 213 to generate the reconstructed image data, the second AI model 216 that has been trained to extract the difference from two image data having the difference, the difference extraction part 205 that inputs the captured image data and the reconstructed image data to the second AI model 216 to extract the difference image data, and the abnormality extraction part 206 that extracts an abnormal portion from the differential image data. Accordingly, the difference can be extracted with high accuracy by using AI for the difference extraction. Further, it is possible to perform the abnormality detection in which the discrepancy with the determination by human eye is reduced by training the second AI model to reflect the difference that can be recognized by human eye.

Further, in accordance with the abnormality detection system of the present disclosure, good-quality images that are easy to collect or images unrelated to the target object can be used as the training data for the second AI model 216. Since the training data can be easily collected, the second AI model 216 can be trained efficiently.

This application claims priority to Japanese Patent Application No. 2023-045392 filed on Mar. 22, 2023, the entire contents of which are incorporated herein by reference.

### INDUSTRIAL APPLICABILITY

The present disclosure is suitable for an abnormality detection system and an abnormality detection method that can train AI using training data that is easy to collect and can perform abnormality detection using AI that is close to normal/abnormal determination by human eye.

### DESCRIPTION OF REFERENCE NUMERALS

101: image acquisition device, 102: abnormality detection device, 103: display output device, 201: still image acquisition part, 202: first AI training part, 203: reconstruction part, 204: second AI training part, 205: difference extraction part, 206: abnormality extraction part, 211: input still image storage part, 212: first AI training data storage part, 213: first AI model, 214: reconstructed image storage part, 215: second AI training data storage part, 216: second AI model, 217: difference image storage part, 300: first AI training data, 301: reconstructed image, 401: background image, 402: foreground image, 403: difference ground truth image, 404: difference image

1. An abnormality detection system for detecting abnormality in captured image data of an object, comprising:
a first AI model trained with a normal image of the object as training data;
a reconstruction part configured to generate reconstructed image data from the captured image data using the first AI model;
a second AI model trained to extract a difference from two image data having the difference;
a difference extraction part configured to extract difference image data from the captured image data and the reconstructed image data using the second AI model; and
an abnormality extraction part configured to extract an abnormal portion from the difference image data,
wherein the second AI model is trained using difference ground truth image data, which is obtained by extracting the difference from the two image data having the difference, and difference image data generated from the two image data using the second AI model, such that the difference image data becomes identical to the difference ground truth image data.

2. The abnormality detection system of claim 1, wherein the two image data having the difference do not include abnormal data.

3. The abnormality detection system of claim 1, wherein the difference ground truth image data is an image data corrected based on the two image data having the difference so as to reflect difference perceived by human eye.

4. An abnormality detection method for detecting abnormality in captured image data of an object, comprising:
generating reconstructed image data from the capture image data using a first AI model trained with a normal image of the object as training data, by a reconstruction part;
extracting difference image data from the captured image data and the reconstructed image data using a second AI model trained to extract a difference from two image data having the difference, by a difference extraction part; and
extracting an abnormal portion from the difference image data, by an abnormality extraction part,
wherein the second AI model is trained using difference ground truth image data, which is obtained by extracting the difference from the two image data having the difference, and difference image data generated from the two image data using the second AI model, such that the difference image data becomes identical to the difference ground truth image data.

5. The abnormality detection method of claim 4, wherein the two image data having the difference do not include abnormal data.

6. The abnormality detection method of claim 4, wherein the difference ground truth image data is an image data corrected based on the two image data having the difference so as to reflect difference perceived by human eye.
